(19) United States
(12) Patent Application Publication
(10) Pub. No.: US 2005/0132861 A1
(43) Pub. Date: Jun. 23, 2005

(54) Apparatus for forming die cuts

(76) Inventors: Guo Rui Deng, Dongguan (CN); Robert E. Workman, Spanish Fork, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/742,970

(22) Filed: Dec. 22, 2003

(51) Int. Cl. B26F 1/14

(52) U.S. Cl. 83/684

(57) ABSTRACT

A die cutting apparatus for forming die cuts from paper and other materials includes a plastic base defining at least one channel therein for receiving at least one blade. The blade has a desired shape to provide a cutting edge with a predetermined contour to substantially match the contour of at least one channel. The channel has a depth that is less than a thickness of the base, and the blade is of a height that allows the blade to be relatively easily formed into relatively complex shapes.

### BACKGROUND

1. Field of the Invention

The present invention relates to an apparatus for forming paper die cuts. More particularly, the present invention relates to a die cutting apparatus formed from plastic or other suitable material for holding a die cutting blade having a desired pattern.

2. Description of the Art

Die cuts are preformed pieces of paper or other cuttable material that are cut into a desired shape. For example, die cuts are often available in various shapes such as teddy bears, hearts, stars, etc. Multiple die cuts are usually packaged together for consumer purchase and may include die cuts formed from various colors of paper.

The die cuts are formed by pressing a blade, which has been formed into the desired exterior shape, against a sheet of paper or any other cuttable material to cut or punch out a section of the paper or other material corresponding to the shape of the blade. Typically, the blade is held in position by a block of wood.

Such die cutting blocks are typically comprised of a block of wood which has a desired pattern laser cut into the wood block. The laser cutting process forms a channel in the wood block for receiving a die cutting blade. The channel extends completely through the wood block but is discontinuous at certain points to keep the interior “cut out” portion of the wood block intact with the remainder of the block. A preformed blade, having a generally rectangular shape, bent to have the same pattern as the pattern cut in the wood block is then inserted into the channel formed therein.

Typically, the wood block is approximately ⅝ to ¾ inches in thickness and the blade is approximately 1 inch in width.

In order to ensure that the blade remains secured within the channel, the blade is essentially press fitted within the channel. Moreover, the desired shape is typically formed from several sections of blade, each of which must be individually and precisely forced into the channel. In order to insert the blade members, a skilled laborer must pound each of the individual blade members into the channel by hand. The blade is forced into the wood block until the back edge of the blade is substantially flush with or even extending slightly beyond the back side of the wood block, leaving a portion of the blade extending above the top surface of the wood block. With the exception of laser cutting the channel into the block, such die cutting blocks have been manufactured in this manner for decades with little, if any, improvement in the manufacturing or assembly processes.

This process of manufacturing such a die cutting instrument is time consuming and labor intensive. As such, the cost to manufacture each die cutting block is relatively high. The retail price of such die cutting blocks have an average retail price of approximately $120 dollars. The primary market for such die cutting blocks are commercial establishments that produce their own sets of die cuts or commercial establishments that allow their customers to use their die cutting machines to create die cuts for a fee. There has not been a die cutting system designed specifically for personal or home use.

One significant improvement to such conventional type die cutting device is described in U.S. patent application Ser. No. 09/896,667 (the '667 application). The '667 application discloses a die cutting block for forming die cuts from paper and other materials. The die cutting block includes a plastic base portion having a recess formed therein. The recess has a particular desired shape formed therein. An insert portion is utilized to wedge a blade between and tightly hold the blade between the base portion and the insert portion. The blade extends above the base portion and insert portion to provide an exposed edge for cutting paper and the like into a desired shape.

While the plastic block disclosed in the '667 application was a significant improvement over the prior art, it would be a further advantage to provide a die cutting block that is less expensive and easy to manufacture, easy to assemble, and capable of being incorporated into and used with any similar die cutting apparatus. It would further be advantageous to provide such a die cutting block that can be manufactured at a price that makes it accessible to the average consumer for home use.

These and other advantages will become apparent from a reading of the following summary of the invention and description of the illustrated embodiments in accordance with the principles of the present invention.

### SUMMARY OF THE INVENTION

Accordingly, a die cutting block configured for cutting one or more sheets of paper is comprised of a base formed from plastic or other suitable material. A steel rule blade, which may be heat treated and toughened to a Rockwell C Hardness of approximately 40 following forming. The ends of the rule are aligned, clamped into position and welded together. The thickness of the base may vary depending upon the height of the steel rule and/or the necessary thickness of the die cutting block for use with a particular die press. A design matching the outline of the steel rule design is formed into the base as by molding.

In one embodiment a channel or slot is formed in the base with the width of the slot or channel formed in the base substantially matching the width of the steel rule, within certain tolerances.

Because the channel for holding the blade in the base is formed directly in the base, the base itself is formed from a single piece of material. Thus, only a single base component need be molded to accommodate the blade.

In one embodiment, the width of the channel for holding the blade is advantageously made slightly smaller than the width of the blade so as to allow formation of an interference fit between the base and the blade to help hold the blade relative to the base.

In another embodiment, the channel for holding the blade is defined by an inner wall and an outer wall. The outer wall is supported by a grid of laterally and longitudinally extending walls defining a plurality of recesses in the base. The walls reduce warping of the base when placed under pressure in use, bias the outside wall supporting the blade to maintain an interference fit against the blade, and reduce the amount of material needed to form each base.

In another embodiment, the base is configured with a plurality of channels for supporting a plurality of blades. In one such embodiment, a blade design includes an outer blade for cutting an outer shape of a design and interior blades are provided to cut interior design features within the outer blade. In another such embodiment, a plurality of blades are provided in the base, with one or more blades of the plurality of blades provided for cutting out a distinct design. For example, a single base could provide a number of distinct channels with associated blades for providing a complete alphabet set on a single base.

In another embodiment, a recess having an outer perimeter having substantially the same design and size as the outer dimensions of the blade is formed in the top surface of the base. The blade is then inserted into the base and a retaining insert is inserted into the space defined by the blade. The base is formed from two pieces, a back member and a blade retaining member. The blade retaining member includes the recess for maintaining the blade. The blade retaining member also includes a blade support structure which extends to the back member so as to provide support to the recess when the blade is being pressed during use.

### BRIEF DESCRIPTION OF THE DRAWINGS

The foregoing summary, as well as the following detailed description of the preferred embodiments is better understood when read in conjunction with the appended drawings. For the purpose of illustrating the invention, there is shown in the drawings embodiments that illustrate what is currently considered to be the best mode for carrying out the invention, it being understood, however, that the invention is not limited to the specific methods and instruments disclosed. In the drawings:

FIG. 1A is a top view of a first embodiment of a die cutting apparatus in accordance with the principles of the present invention;

FIG. 1B is a partial detail top view of the die cutting apparatus of FIG. 1A;

FIG. 1C is a cross-sectional side view of the die cutting apparatus illustrated in FIG. 1A;

FIG. 2A is a top view a second embodiment of a die cutting apparatus in accordance with the principles of the present invention;

FIG. 2B is a side view of the die cutting apparatus illustrated in FIG. 2A;

FIG. 3A is a top view of a third embodiment of a die butting apparatus in accordance with the principles of the present invention;

FIG. 3B is a side view of the die butting apparatus illustrated in FIG. 3A;

FIG. 4A is a top view of the back cover of the die cutting apparatus illustrated in FIG. 3A;

FIG. 4B is a cross-sectional side view of the back cover illustrated in FIG. 4A;

FIG. 5A is a top view of the blade retaining member illustrated in FIG. 3A;

FIG. 5B is a bottom view of the blade retaining member illustrated in FIG. 5A;

FIG. 5C is a cross-sectional side view of the blade retaining member illustrated in FIG. 5A/

FIG. 6A is a top view of the first blade illustrated in FIG. 3A;

FIG. 6B is a side view of the first blade illustrated in FIG. 6A.

FIG. 7A is a top view of the blade retaining insert illustrated in FIG. 3A;

FIG. 7B is a side view of the blade retaining insert illustrated in FIG. 7A;

FIG. 8A is a top view of the second blade illustrated in FIG. 3A; and

FIG. 8B is a side view of the second blade illustrated in FIG. 8A.

### DETAILED DESCRIPTION OF THE ILLUSTRATED EMBODIMENTS

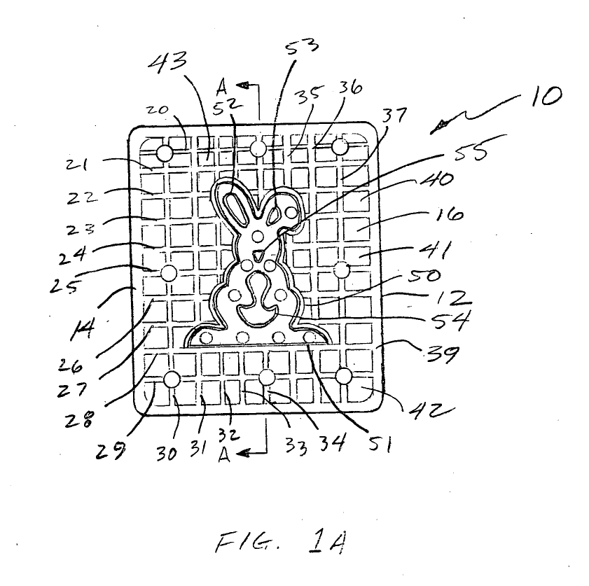

Referring to the drawings wherein like numerals indicate like elements throughout, there is shown in FIG. 1A a first embodiment of a die cutting apparatus, generally indicated at 10, in accordance with the principles of the present invention. The die cutting apparatus 10 is configured for cutting one or more sheets of paper or other desired material by firmly pressing the die cutting apparatus 10 (and more specifically the blades) against such material. The die cutting apparatus 10 is comprised of a one piece base 12. The base is defined by an outer perimeter wall 14 and a substantially flat back panel 16 that provides a smooth back surface and is coextensive with the perimeter wall 14. Within the perimeter wall are a plurality of transversely and laterally extending walls 20-37 that extend from the back panel 16 and are substantially planar with the top surface 39 of the perimeter wall 14. The walls 20-37 define a plurality of recesses, such as recesses 40-43.

Also depending from the back wall 14 is a design portion 50 supporting five blades 51, 52, 53, 54 and 55. As shown in FIG. 1B (a close-up view of a portion of the die cutting apparatus 10), each blade 51 and 53 is vertically supported within the base 12. The blade 51 is inserted within a channel 60 defined by contoured wall 62 and an interior portion 64 of the design portion 50 that is integrally formed with the base 12. The blade 53 is vertically supported by a contoured channel 66 formed in the design portion 50. Circular recesses 68 are formed in the interior portion 64 to reduce the amount of material needed to form the base 12 and to also add rigidity to the base 12 in the design portion 50. Likewise, the grid of walls 34, 35, 36, 22, 23, and 24 add structural support to the contoured wall 62 while also maintaining resistance to warping of the base 12 resulting from forces applied during use.

The blades 51 and 53 are inserted approximately one half to one third of their overall height into their respective channels 60 and 66. The blades 51 and 53 are secured within the channels 60 and 66 by applying an adhesive 70 in the channels 60 and 66 prior to inserting the blades 51 and 53. Once solidified, the adhesive 70 prevents the blades from becoming disengaged from the channels. As such, the width of each channel does not have to be so tight as to require the blades to be forced under significant pressure into each respective channel, as is the case with prior art wood type die cutting devices previously discussed. Instead, the adhesive can be applied to the bottom or inserted edge of each blade and/or in the channel prior to inserting each blade into a channel.

The blades 51 and 53 are formed from 6 mm steel rule. Prior art devices typically use a 12 mm steel rule. By decreasing the height of the steel rule used to form the blades 51 and 53, a thinner steel rule can be used. The use of a thinner steel rule material allows tighter and more intricate bends to be formed in the blades to create more complex designs than has be possible in the past. Because the blades are typically subjected to 6000 lbs. of pressure in use, merely using conventional 12 mm steel rule of a thinner gage would result in the blades buckling under pressure. By shortening the height, however, such buckling is eliminated even though a thinner rule is employed. As a result, the height of the blade above the base is less than conventional die cutting devices resulting in a blade cutting depth that allows for fewer sheets of paper to be simultaneously cut. In the consumer market, however, the ability to cut one to four sheets at a time is usually sufficient. Of course, commercial dies on the other hand can typically cut several more sheets simultaneously, but for the home market, the die cutting device is significantly more than adequate.

The ease of manufacture and assembly of the die cutting apparatus 10 of the present invention is a significant step forward in the art of such die cutting devices. Specifically, prior art die cutting devices either require skilled technicians to assemble using sophisticated presses and block forming machines or are comprised of multiple pieces that must be assembled. The present invention, however, can be formed by injection molding the single piece base, forming the individual blade or blades and adhesively attaching the blade or blades directly into the base. A release pad, such as a neoprene pad, is then placed over the blades and adhesively attached to the base. Application of the principles of the present invention results in an approximately thirty-five percent savings in the cost of manufacturing of a die cutting apparatus, due to a reduction in the number of individual pieces needed to form each device and the ease of assembling each device.

As shown in FIG. 1C, which is a cross-sectional view along section A-A shown in FIG. 1A, the channel 60 which supports the outer blade 51 as well as the other channels 80 and 82 which support blades 54 and 55, respectively, support approximately one third to one half of the height of the blades 51, 54 and 55. The design portion 50 is integral with the base 12 with various recesses 90, 91 and 92 formed in the base 12 to reduce the amount of material used to form the base 12 and to prevent flexing of the base 12 when the base 12 and blades 51, 54 and 55 are used in a die cutting press (not shown). As previously discussed, because the steel rule used to form the blades 51, 54 and 55 is of a height of approximately 5-7 mm, with approximately ½ to ⅓ of the blades embedded into and supported by the base 12, the blade can be formed into more intricate shapes than typical 12 mm steel rule due to its relative ease in bending. That is, because a 6 mm steel rule blade is easier to bend than a 12 mm steel rule blade, the blade can be bent into tighter radii to form shapes of a greater complexity than can be done with a 12 mm steel rule using current bending techniques and machinery. In addition, by using steel rule that is half the width of conventional steel rule used in such die cutting devices, a die cutting device 10 according to the present invention uses half as much steel rule material as that to form a conventional die cutting device of similar configuration.

Each blade 51, 54 and 55 is formed from steel that has been bent into a preformed shape. The blades 51, 54 and 55 are formed by first providing an elongate strip of steel, forming a desired contour in each blade by forming bends in the strip and then attaching the two opposing ends of the strip with a transversely extending weld.

A die cutting device 10, according to the principles of the present invention can be manufactured for approximately one third to one half less cost of currently available die cutting devices of a similar configuration. The reduction in cost stems from both a reduction in the number of parts and quantities of such materials used to manufacture each device 10 as well as the ease of manufacturing and assembly of each device 10.

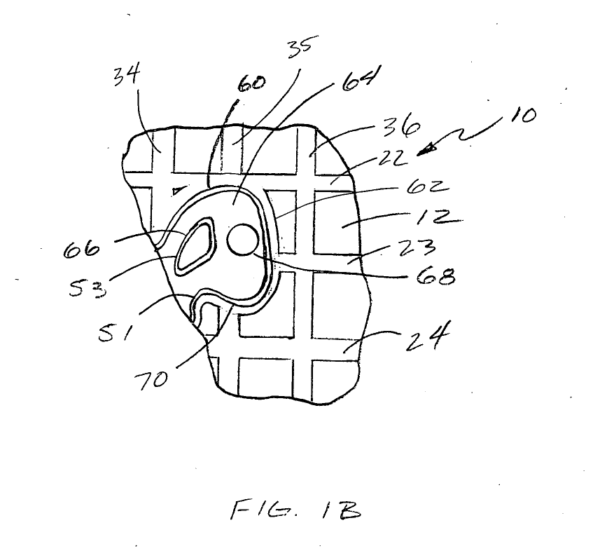

Another significant advantage of a die cutting device, generally indicated 100 in accordance with the principles of the present invention, includes the capability of providing multiple independent shapes or designs in a single die cutting device 100. As shown in FIGS. 2A and 2B, the die cutting device 100 provides a plurality of independent design shapes 102, 104, 106 and 108 formed by blades 112, 114, 116 and 118, respectively. In this example, the letter “Z” is provided in four different fonts. Each blade 112, 114, 116 and 118 is independently supported within the base 120 by insertion into and retention by corresponding channels similar to those shown in FIGS. 1A-1C.

A top cap or plate 123, which fits around the blades 112, 114 116 and 118 is provided over the grid of the base 120. The plate 123 may be coextensive with the base 120 as shown or slightly inset and set within a recess formed in the top of the base 120. A release pad 121 indicated by dashed lines, may be attached to the top surface 125 of the plate 123. The top plate 123 prevents the release pad 121 from being cut by the underlying wall grid in the base 120, such as that shown in FIG. 1A. The release pad 121 has a thickness approximately equal to the height of the blades 112, 114, 116 and 118 above the top surface 125 of the plate 123. The release pad 121 is formed from a foam rubber material such as neoprene or a foam pad that is relatively easily compressible to expose the cutting edges or top edges of the blades 112, 114, 116 and 118 when the die cutting apparatus 100 is being pressed against a material (such as paper, card stock, fabric, or other sheet type materials) to be cut. That is, as the blades are pressed against a material or stack of materials, such as a stack of paper, the release pad 121 is compressed by the material as the blades are thrust into the material for cutting. As the blades are removed from engagement with the material, the release pad 121 expands back to its pre-cutting position (as shown in FIG. 2B) to remove the material being cut from engagement with the blades particularly on the interior sides of the blades. The release pad 121 is attached to the top surface 125 of the plate 123 with a layer of adhesive at least partially covering a portion of the top surfaces of the grid (not visible).

Because the present invention is capable of housing a plurality of independent blade designs for cutting out various shapes, a single cutting device 100 can be used for multiple die cut shapes. One particular application of particular utility is to provide a complete alphabet and/or number set on a single die cutting apparatus. As such, a user could purchase a complete alphabet/number set of a particular font by purchasing a single die cutting apparatus according to the present invention containing all such alphanumeric characters. The current present art practice is to provide a single alphanumeric character on each die cutting apparatus. Thus, to possess a complete alphabet set of a particular font, one must obtain twenty-six separate die cutting devices. This limitation is a result of previous techniques employed to manufacture such devices and limitations, including cost and assembly, associated with providing multiple independent shapes on a single die cutting apparatus.

To cut out a particular letter from a sheet of material or stack of sheets of material, one could simply place the stack under the particular letter for which cutting is desired, and press the die cutting device into the material, as by placing the device and material in a die cutting press.

For example, if one desires to make a cut out from the lower left hand “Z” 116 of the die cutting device shown in FIG. 2A, one could simply place the design 116 over a corner of a sheet of paper so that the corner of the paper extends around the design 116 formed by the blade 106. If the corner of the paper is not in contact with any of the other blades 112, 114 and 118, only the blade 116 will cut the paper. By pressing the device 100 against the paper, the blade 116 will cut the “Z” 106 out of the paper. A similar technique could be used for any of the other designs 102, 104 or 108 of the device 100 or any combination of designs as desired.

It is thus contemplated that a die cutting device according to the present invention could be of any overall size and or shape so as to allow for complete sets of designs to be included on a single die cutting device. An alphabet set is but one example of such a complete set of designs. Because some die cutting devices known in the art in which such a die cutting device could be readily employed may have a limited width within which such a die cutting device could be inserted and effective pressed, the die cutting devices of the present invention may have a length that is substantially longer than the width. As such, the die cutting devices may be elongate, rectangular-shaped to provide a complete set of designs in a device that can be inserted into a known die cutting device such as the SIZZIX die cutting device known in the art. As such, only a portion of the die cutting device may be pressed at any given time to cut out a particular shape or set of shapes. Thus, for example, the device 100 could be extended in length to house two columns of “Z” shapes with three or more “Z”s in each column. The length of the device would thus correspond to the number of designs included in the device.

A die cutting apparatus, in accordance with the principles of the present invention, may include blades having various contours and shapes, both enclosed shapes and open shapes into a single cutting apparatus. Thus, while various channels illustrated herein have shown generally closed shapes, it is also part of the present invention to form channels that form open shapes, such as open-sided contours, as desired. Blades positioned within such channels, however, can be inserted and attached to the base as herein described.

In addition, in order to be adaptable to different pressing machines used for die cutting purposes known in the art, the thickness of the combination of the base 120 and the blades 112, 114, 116 and 118 that extend above the base (i.e., the overall thickness or height of the device 100) can be produced in any desired thickness to allow the die cutting device 100 to be used in virtually any pressing device known in the art. That is, many die cutting presses are configured to press a die cutting device of a particular thickness and are generally manufactured to be used with a particular die cutting device. By adjusting the thickness of the base 120, the die cutting device 100 could be effectively adjusted in thickness to be acceptable and therefore usable with a particular die cutting machine known in the art. Because the blades only extend a relatively small distance into the base 120, unlike prior art device, the thickness of the base can be easily modified to allow use of the device 100 in virtually any pressing device known in the art for use with such devices 100.

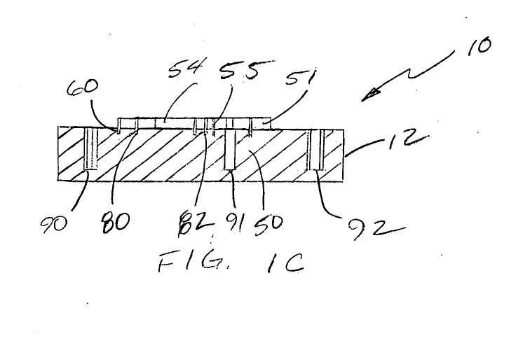

Another embodiment of a die cutting device, generally indicated at 200, is illustrated in FIGS. 3A and 3B. The die cutting device 200 is comprised of a base assembly 202 and a plurality of blades 204 and 206. The base assembly 202 is comprised of a back cover 203 formed from a back plate 208 and four side walls 210, 212, 214 and 216 depending therefrom that form the sides of the device 200. The back cover 203 forms a receptacle or recess for receiving a blade retaining plate 218. The back cover 203 provides lateral support and rigidity to a blade retaining member or plate 218 to prevent warping of the plate 218 when the blades 204 and 206 are subjected to pressure in use. The back cover 203 also provides a cosmetic cover to provide a smooth, generally rectangular outer surface resembling that of a conventional die cutting device. The blade retaining plate 218 defines a character defined recess 220 (in this example the letter “A”) which may be of virtually any configuration. The recess 220 is approximately one quarter to one half the height of the blades 204 and 206, but less than the overall thickness of the back cover 203. The recess 220 need only be deep enough to provide sufficient support for the blade when the blade is subjected to force under pressure from a die cutting machine (not shown). A blade retaining insert 222 is positioned within the outer blade 204. The blade retaining insert 222 has a thickness that is approximately the depth of the recess 220 such that the top surface 224 of the retaining plate 218 is substantially in plane with top surface 226 of the insert 222. The blade retaining insert 222 not only helps to retain the outer blade 204 within the recess 220 by wedging the blade 204 by friction fit within the recess 220, but also retains the second or inner blade 206 therein. The blade retaining insert 226 has a shape that substantially matches in size and configuration the inside surface of the blade 204. In order to ensure that the blade retaining insert and associated blades 204 and 206 remain within the recess 220, an adhesive may be applied within the recess 220 during assembly to adhesively secure the insert 222 and blades 204 and 206 relative thereto. Likewise, the blade retaining plate 218 may be adhesively attached to the back cover 203. A hole 228 is provided in the blade retaining plate 218 to allow air to flow from the space formed between the back cover 203 and the blade retaining insert 218 during assembly as the blade retaining insert 218 is fitted within the back cover 203. As further shown in FIG. 2B, a release pad 230 shown in dashed lines may be adhesively attached to the top surface 224 of the blade retaining plate 218. The combination of the blade retaining plate 218 and back cover 203 produces a die cutting device that has the appearance, shape and thickness of a conventional die cutting device known in the art while substantially reducing the amount of material needed to manufacture such a device and simplifying the manufacturing process to produce a die cutting device that will not warp or flex during use (as such warping or flexing would otherwise cause inconsistent cuts with the blades 204 and 206).

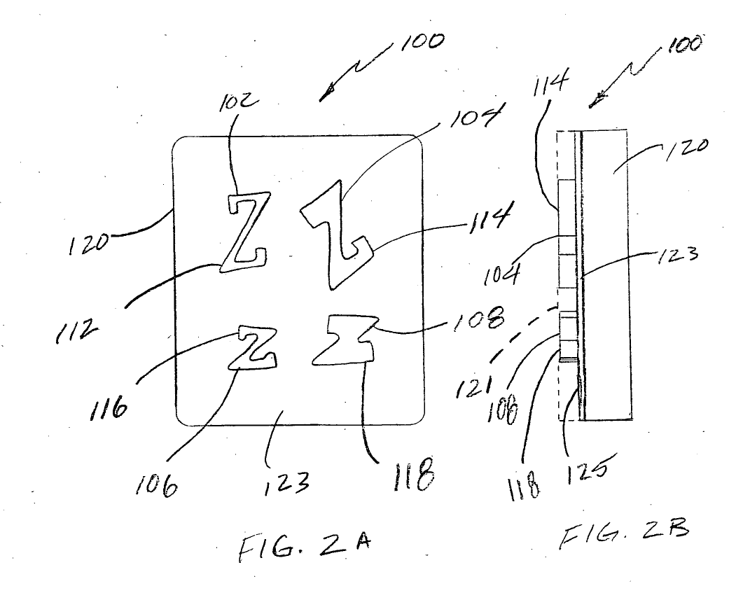

FIGS. 4A-8B illustrate the various individual components that make up the die cutting devise illustrated in FIGS. 3A and 3B. Referring now to FIGS. 4A and 4B, there is shown the back cover 203. The back cover is formed from a back plate 208 and four side walls 210, 212, 214 and 216 that define recess 219 therein between. The side walls 210, 212, 214 and 216 depend from and are integrally formed with the back plate 208. The height of the side walls 210, 212, 214 and 216 is such that when the blade retaining insert 218 is placed within the recess 219 of the back cover 208, the top surface 224 of the insert 218 is substantially coplanar with the top surface 240 defined by the side walls 210, 212, 214 and 216 (see FIGS. 3A and 3B).

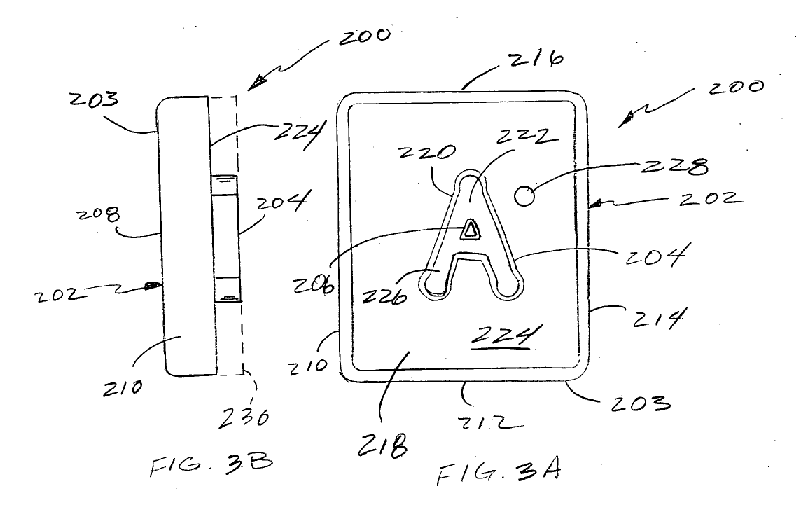

Referring now to FIGS. 5A, 5B and 5C, there is illustrated the blade retaining insert 218. As shown in FIGS. 5A and 5, the top surface 224 defines a recess 220 therein for receiving the blades 204 and 206 (see FIG. 3A). The recess is provided with a particular design outline (in this example, the outline of a particular font of the letter “A”). The dimensions of the perimeter 242 of the insert 218 is such that it fits within the back cover 203 (see FIGS. 3A and 3B) for being secured thereto.

As further shown in FIGS. 5B and 5C, the blade retaining insert 218 includes a plurality of side walls 244, 246, 248 and 250 that depend from the back surface 252 of a top plate 254 that defines the recess 220 in the top surface 224 thereof (see FIG. 5A). Each side wall 244, 246, 248 and 250 have a height that is substantially the same as the depth of the recess 219 of the back cover 203 (see FIG. 4B). Also, depending from the back surface 254 of the recess 220 are blade support members 260 and 262. The blade support members 260 and 262 extend from the back surface 254 of the recess 220 to be coextensive with the top surface 264 defined by the side walls 244, 246, 248 and 250. The blade support members 260 and 262 lie beneath the blades 204 and 206, respectively, so as to provide support for the blades when the blades are being subjected to pressure as when used in a die cutting machine (not shown). The blade support member 260 comprises a wall that inscribes the perimeter 266 of the back surface 254 of the recess 220. The blade support member 260 may be substantially directly below the blade 204 when assembled to provide vertical support to the blade 204 in use. The blade support member 262, on the other hand, comprises a post member having an outer perimeter shape that substantially matches the shape of the blade 206. Again, the blade support member 262 provides vertical support for the blade 206 when the blade 206 is subjected to vertical pressure.

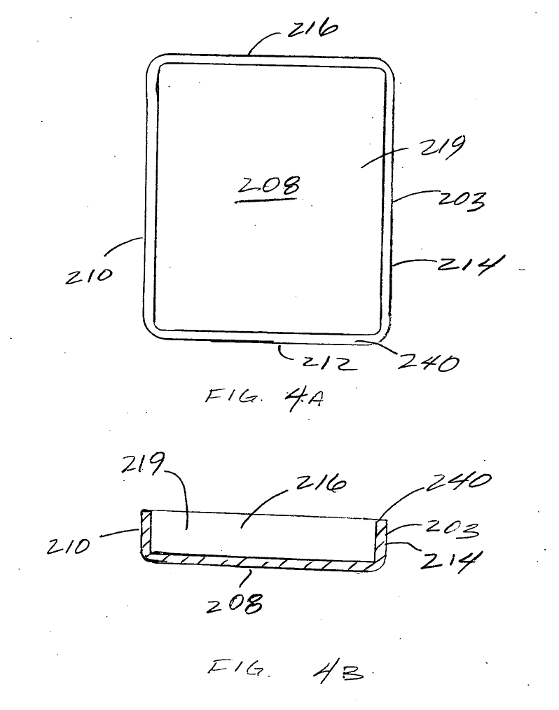

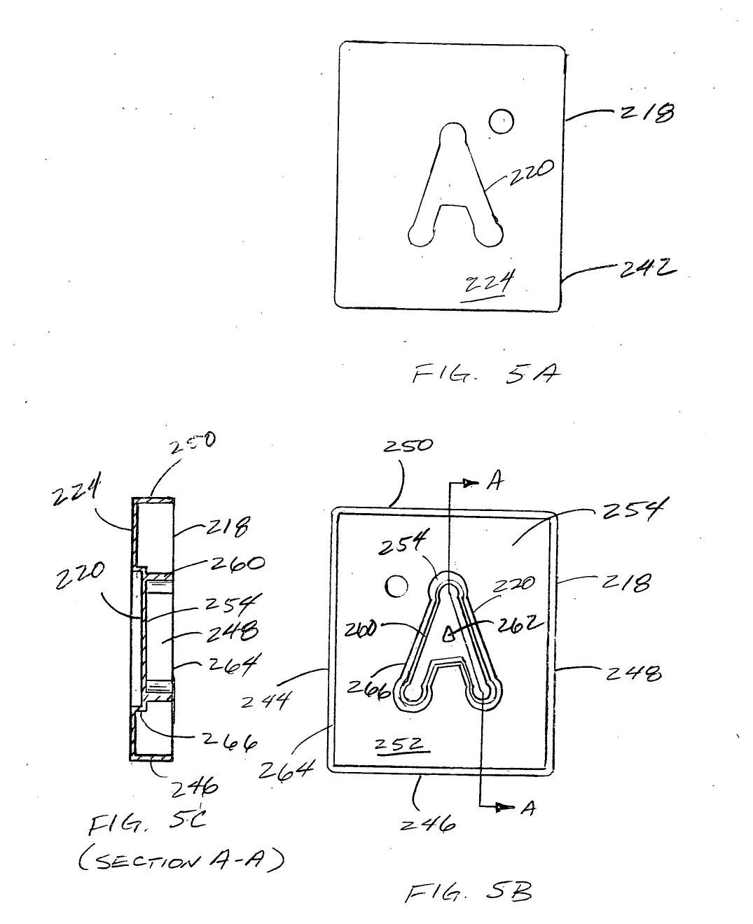

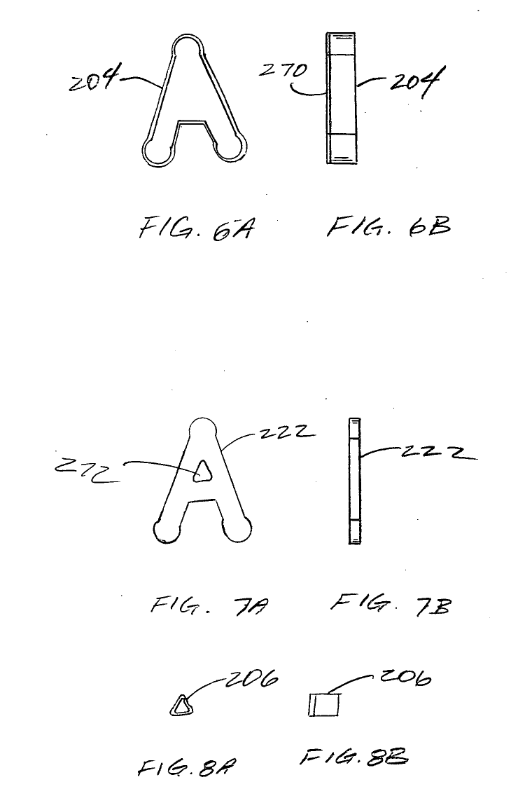

Referring now to FIGS. 6A and 6B, the blade 204 is formed from steel rule, with ends welded together to form a single enclosed shape (in this example, the outline of the letter “A”). The blade 204 has a sharpened top edge 270 for cutting a medium, such as paper or the like, into the shape of the blade 204. As shown in FIGS. 7A and 7B, a blade retaining insert 222 is comprised of a relatively thin member that has an outer perimeter shape that substantially matches the inside shape of the blade 204. The blade retaining insert 222 is substantially the same thickness as the depth of the recess 220 (see FIG. 5C). The insert 222 also includes a blade retaining aperture 272 configured for receiving and retaining the blade 206 (see FIGS. 8A and 8B) therein. The size and shape of the aperture 272 is such that a friction fit is formed between the insert 222 and the blade 206 to hold the blade 206 therein.

While the methods and apparatus of the present invention have been described with reference to certain embodiments, it is contemplated that upon review of the present invention, those of skill in the art will appreciate that various modifications and combinations may be made to the present embodiments without departing from the spirit and scope of the invention as recited in the claims. The claims provided herein are intended to cover such modifications and combinations and all equivalents thereof. Reference herein to specific details of the illustrated embodiments is by way of example and not by way of limitation.

1. A die cutting apparatus, comprising:
a one piece plastic base defining a bottom surface, a top surface and at least one channel formed in said top surface having a width for supporting at least one blade therein and a depth that is less than a thickness of said base;
at least one blade partially inserted within said at least one channel and extending above said top surface, said at least one blade providing a cutting edge; and
an adhesive interposed between said at least one channel and said at least one blade for maintaining said at least one blade in said at least one channel.

2. The apparatus of claim 1, wherein said base further includes a plurality of recesses formed therein.

3. The apparatus of claim 2, wherein said plurality of recesses are defined by a plurality of walls integrally formed with said base.

4. The apparatus of claim 3, wherein said plurality of walls form a grid.

5. The apparatus of claim 2, wherein said recesses are formed in said top surface of said base.

6. The apparatus of claim 1, wherein said at least one channel is defined in a design portion integrally formed with said base.

7. The apparatus of claim 6, wherein an upper surface of said design portion forms a portion of said top surface of said base.

8. The apparatus of claim 6, wherein said at least one channel is disposed proximate a perimeter of said design portion.

9. The apparatus of claim 1, wherein said at least one channel has a depth that is less than half the thickness of said base.

10. The apparatus of claim 9, wherein said at least one channel has a depth that is approximately one quarter of the thickness of said base.

11. The apparatus of claim 1, further comprising a release pad attached to said top surface of said base.

12. The apparatus of claim 1, further comprising a top plate attached to said top surface of said base.

13. The apparatus of claim 1, wherein said at least one channel comprises a first channel and a second channel, said first channel defining a perimeter of a first shape and said second channel defining a second shape interior to said first shape.

14. The apparatus of claim 13, wherein said at least one blade defines a first blade disposed within said first channel and a second blade disposed within said second channel.

15. A die cutting apparatus, comprising:
a one piece plastic base defining a bottom surface, a top surface and a plurality of channels formed in said top surface, each having a width for supporting at least one blade therein and each having a depth that is less than a thickness of said base; and
a plurality of blades providing a plurality of cutting edges, each of said plurality of blades inserted in one of said plurality of channels and extending above said top surface.

16. The die cutting apparatus of claim 15, further comprising an adhesive interposed between said plurality of blades and said plurality of channels for maintaining said plurality of blades in said plurality of channels.

17. The apparatus of claim 15, wherein said base further includes a plurality of recesses formed therein.

18. The apparatus of claim 17, wherein said plurality of recesses are defined by a plurality of walls integrally formed with said base.

19. The apparatus of claim 18, wherein said plurality of walls form a grid.

20. The apparatus of claim 17, wherein said plurality of recesses are formed in said top surface of said base.

21. The apparatus of claim 15, wherein said plurality of channels are each defined by one of a plurality of design portions integrally formed with said base.

22. The apparatus of claim 21, wherein an upper surface of said plurality of design portions form a portion of said top surface of said base.

23. The apparatus of claim 21, wherein said plurality of channels are each disposed proximate a perimeter of each of said plurality of design portion.

24. The apparatus of claim 15, wherein said plurality of channels have a depth that is less than half the thickness of said base.

25. The apparatus of claim 24, wherein said plurality of channels have a depth that is approximately one quarter of the thickness of said base.

26. The apparatus of claim 15, further comprising a release pad attached to said top surface of said base.

27. The apparatus of claim 15, further comprising a top plate attached to said top surface of said base.

28. The apparatus of claim 15, wherein said plurality of channels and said plurality of blades define a plurality of independent shapes.

29. The apparatus of claim 28, wherein said plurality of independent shapes comprise a plurality of alphabet letters.

30. The apparatus of claim 29, wherein said plurality of alphabet letters comprise a complete alphabet set in a particular font.

31. A die cutting apparatus, comprising:
a blade retaining member defining a substantially flat top surface and at least one first recess formed in said top surface, said at least one first recess defining at least one outline of a desired shape;
at least one blade inserted into said at least one first recess;
a blade retaining insert inserted within said at least one first recess for maintaining said at least one blade within said at least one first recess;
a back cover defining a second recess for receiving at least a portion of said blade retaining member therein and being coupled to said blade retaining member;
at least one support structure interposed between said at least one first recess and said second recess of said back cover for vertically supporting said at least one first recess relative to said second recess.

32. The apparatus of claim 31, wherein said back cover comprises a back plate and four side walls depending upwardly therefrom, said four side walls having a height substantially equal to a thickness of said blade retaining member.

33. The apparatus of claim 31, wherein said at least one support structure inscribes a back surface of said at least one first recess.

34. The apparatus of claim 31, wherein said a blade retaining insert defines at least one aperture therein for receiving and retaining at least one second blade therein.

35. The apparatus of claim 31, wherein said at least one first recess has a depth that is less than half a height of said at least one blade.

36. The apparatus of claim 31, wherein said at least one support structure is positioned in substantial alignment with said at least one blade for providing vertical support thereto.

37. A die cutting apparatus, comprising:
a blade retaining member defining a substantially flat top surface and at least one first recess formed in said top surface, said at least one first recess defining at least one outline of a desired shape;
at least one blade inserted into said at least one first recess;
a blade retaining insert inserted within said at least one first recess for maintaining said at least one blade within said at least one first recess; and
a back cover configured for receiving said blade retaining member therein and for supporting said blade retaining member.

38. The apparatus of claim 37, wherein said back cover defines a second recess for receiving at least a portion of said blade retaining member therein, said back cover being coupled to said blade retaining member.

39. The apparatus of claim 38, wherein said back cover comprises a back plate and four side walls depending upwardly therefrom, said four side walls having a height substantially equal to a thickness of said blade retaining member, said back cover receiving said blade retaining member therein such that a top surface defined by said four side walls is substantially coplanar with a top surface of said blade retaining member.

40. The apparatus of claim 38, further comprising at least one support structure interposed between said at least one first recess and said second recess of said back cover for vertically supporting said at least one first recess relative to said second recess.

41. The apparatus of claim 37, wherein said at least one support structure extends proximate a perimeter of said at least one first recess.

42. The apparatus of claim 37, wherein said at least one support structure comprises a wall integrally formed with said at least one first recess.

43. The apparatus of claim 37, wherein said a blade retaining insert defines at least one aperture therein for receiving and retaining at least one second blade therein.

44. The apparatus of claim 37, wherein said at least one first recess has a depth that is less than half a height of said at least one blade.

45. The apparatus of claim 37, wherein said at least one support structure is positioned in substantial alignment with said at least one blade for providing vertical support thereto.
